(19) United States
(12) Patent Application Publication
(10) Pub. No.: US 2006/0231993 A1
(43) Pub. Date: Oct. 19, 2006

(54) Bushing with performance tuning features

(76) Inventors: Brent R. Collyer, Wellesley (CA); Daniel R. Adema, Kitchener (CA); Christopher W. Forrest, Auburn, IN (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/426,816

(22) Filed: Jun. 27, 2006

Related U.S. Application Data
(63) Continuation of application No. 10/288,232, filed on Nov. 5, 2002, now abandoned.

(51) Int. Cl. B60G 11/12; F16F 1/44

(52) U.S. Cl. 267/270; 267/293

(57) ABSTRACT

A bushing is shown to include an inner metal component having a performance tuning feature integrated therewith. An elastomer is bonded to the inner metal component. The performance tuning feature may include one or more ribs extending radially outwardly from and circumferentially about the main elongated body portion of the inner metal component.

### BACKGROUND OF THE INVENTION

The present invention relates to bushings generally, and more specifically, to bushings having performance tuning features.

Bushings are typically used in a variety of vehicle suspensions. One common use of bushings in vehicle suspensions is to facilitate connection between a vehicle suspension component and another vehicle suspension component, or alternatively, between a vehicle suspension component and the vehicle frame or a frame hanger associated therewith. Conventional bushings used for this purpose typically have three layers. An inner metal component, such as a barpin or thru-bolt, typically forms the first layer. An elastomer typically surrounds the inner metal component, forming the second layer. An outer metal sleeve typically surrounds the elastomer, forming the third layer. Conventional bushings are also referred to as canned bushings by those skilled in the art.

Sleeveless bushings have also been developed. Sleeveless bushings eliminate the outer metal sleeve, i.e., third layer. Sleeveless bushings are also referred to as spool bushings by those skilled in the art. Those skilled in the art will recognize that sleeveless bushings are ordinarily less expensive than conventional three-layer bushings having an outer metal sleeve. Those skilled in the art will further appreciate that sleeveless bushings reduce suspension system weight, which, in the case of commercial vehicles, translates into greater payload capacity.

For purposes of background, FIG. 1 illustrates a vehicle frame 10, a vehicle axle 12 and a vehicle suspension generally designated 14, which suspends frame 10 above axle 12 in a spaced relationship therewith. A frame hanger 16 depends from frame 10 to receive the leaf spring eye portion of a leaf spring 18 positioned at the proximal end of the leaf spring. A bushing 20 is installed within the leaf spring eye portion of leaf spring 18 to facilitate pivotal connection of the leaf spring to frame hanger 16.

An axle clamp assembly 22 clamps axle 12 to vehicle suspension 14, including leaf spring 18. The distal end of leaf spring 18 serves as a mounting surface for an air spring 26, which is connected to frame 10 by way of an air spring mounting bracket 28.

As illustrated in FIG. 1, bushing 20 pivotally connects leaf spring 18 to frame hanger 16. Accordingly, bushing 20 would be subject to static loads, roll moments, lateral forces, longitudinal (fore-aft) forces, and torque caused by acceleration and braking of the vehicle.

One recognized problem of bushings is their ineffective compliance with static loads, roll moments, lateral forces, longitudinal forces and torque. For example, prior art bushings are unable to tune for desired bushing stiffness for vertical, horizontal, longitudinal, conical and torque forces, primarily due to the uniform rigidity and shape. This uniform rigidity and shape is present in both the elastomer and metal inner component

Prior art bushings have incorporated performance tuning features to enhance their compliance with such forces. U.S. Pat. No. 5,996,981 discloses a bushing that includes performance tuning features in the form of voids positioned in the elastomer surrounding the inner metal component. The voids have different geometric formations and orientations in order to accommodate desired vertical, horizontal, and conical bushing stiffness. Nevertheless, smaller-sized leaf spring eyes cannot accommodate these physically larger bushings. Accordingly, those skilled in the art will appreciate that physical compatibility is desired for such use.

Prior art bushings generally do not permit one mode of bushing performance to be optimized independently of another mode. For example, prior art bushings typically do not permit conical stiffness to be increased without hampering fore/aft performance.

In view of the foregoing, it is desirable to develop a bushing that effectively tailors performance in each of its modes independently of its other modes.

It is further desirable to develop a versatile bushing that may be accommodated by any leaf spring eye.

It is further desirable to develop a smaller and more compact bushing that provides performance tuning.

It is further desirable to develop a durable bushing that provides performance tuning.

It is further desirable to develop a bushing having performance tuning capability which is constructed to permit manufacturing simplicity.

It is further desirable to develop a sleeveless bushing that provides performance tuning.

It is further desirable to develop a bushing that provides performance tuning.

It is further desirable to develop a bushing that integrates a performance tuning feature with the inner metal component of the bushing.

It is further desirable to develop a bushing that includes a performance tuning feature in the form of a rib or flange extending radially outwardly from and at least partially circumferentially about the main elongated body portion of the inner metal component.

It is further desirable to develop a bushing that includes a performance tuning feature in the form of a plurality of ribs positioned axially along the length of the elongated body portion of the inner metal component.

These and other desired benefits of the preferred forms of the invention will become apparent from the following description. It will be understood, however, that a device could still appropriate the claimed invention without accomplishing each and every one of these desired benefits, including those gleaned from the following description. The appended claims, not these desired benefits, define the subject matter of the invention. Any and all benefits are derived from the preferred forms of the invention, not necessarily the invention in general.

### BRIEF SUMMARY OF THE INVENTION

The present invention is directed to a bushing having a performance tuning feature. The bushing includes an inner metal component. The performance tuning feature is integrated with the inner metal component. The inner metal component typically comprises a barpin or is adapted to accommodate a thru-bolt. The bushing also includes an elastomer that is bonded to the inner metal component. The bushing is preferably installed within a leaf spring eye.

The performance tuning feature of the present invention includes geometrical alterations or extensions of the inner metal component of the bushing. In one embodiment of the present invention, the performance tuning feature is a rib extending radially outwardly from and at least partially circumferentially about the elongated body portion of the inner metal component. In another embodiment of the present invention, the performance tuning feature is a centrally located rib extending radially outwardly and circumferentially about the elongated body portion of inner metal component. In yet another embodiment, the performance tuning feature comprises a plurality of ribs axially positioned along the length of the elongated body portion of the inner metal component. In still another embodiment, the performance tuning feature comprises one or more ribs extending axially along the length of the elongated body portion of the inner metal component. In certain preferred embodiments, the performance tuning feature(s) are formed by gradually radially outwardly tapering the outer diameter of the inner metal component. In certain of these embodiments, the outer diameter of the inner metal component at a first position along the body thereof is greater than at a second position along the body thereof.

### BRIEF DESCRIPTION OF THE SEVERAL VIEWS OF THE DRAWING

Throughout this description, reference has been and will be made to the accompanying views of the drawing wherein like subject matter has like reference numerals, and wherein:

FIG. 1 is a side elevational view of a conventional vehicle frame, vehicle axle and vehicle suspension;

FIG. 2 is an exploded perspective view of a first embodiment of a sleeveless bushing constructed in accordance with the principles of the present invention, and a leaf spring eye;

FIG. 3 is a sectional view of the bushing and leaf spring eye illustrated in FIG. 2, shown with the bushing installed within the leaf spring eye, and taken along lines 3-3 thereof;

FIG. 4 is a sectional view of a leaf spring eye and a second embodiment of a bushing installed therein constructed in accordance with the principles of the present invention;

FIG. 5 is a perspective view of the inner metal component of a third embodiment of a bushing constructed in accordance with the principles of the present invention;

FIG. 6 is a sectional view of a leaf spring eye and a bushing installed therein constructed in accordance with the principles of the present invention having the inner metal component illustrated in FIG. 5 and oriented in a first position within the leaf spring eye;

FIG. 7 is a sectional view of a leaf spring eye and the bushing illustrated in FIG. 6 installed therein and oriented in a second position within the leaf spring eye;

FIG. 8 is a sectional view of a leaf spring eye and a fourth embodiment of a bushing installed therein constructed in accordance with the principles of the present invention;

FIG. 9 is a perspective view of the inner metal component having an alternative construction of its integrated performance tuning features;

FIG. 10 is a perspective view of the inner metal component having yet another construction of its integrated performance tuning features;

FIG. 11 is a sectional view of a leaf spring eye and a bushing installed therein constructed in accordance with the principles of the present invention having an inner metal component with an alternative construction of its integrated performance tuning features and oriented in a first position within the leaf spring eye;

FIG. 12 is a sectional view of the leaf spring eye and bushing illustrated in FIG. 11 but wherein the bushing is oriented in a second position within the leaf spring eye;

FIG. 13 is a perspective view of another bushing constructed in accordance with the principles of the present invention;

FIG. 14 is a side elevational view of the bushing illustrated in FIG. 13 having an inner metal component with integrated performance tuning features;

FIG. 15 is another side elevational view of the bushing illustrated in FIG. 13, wherein the elastomer layer is partially cut away; and

FIG. 16 is a top plan view of the inner metal component used in the bushing illustrated in FIG. 13.

### DETAILED DESCRIPTION OF THE INVENTION

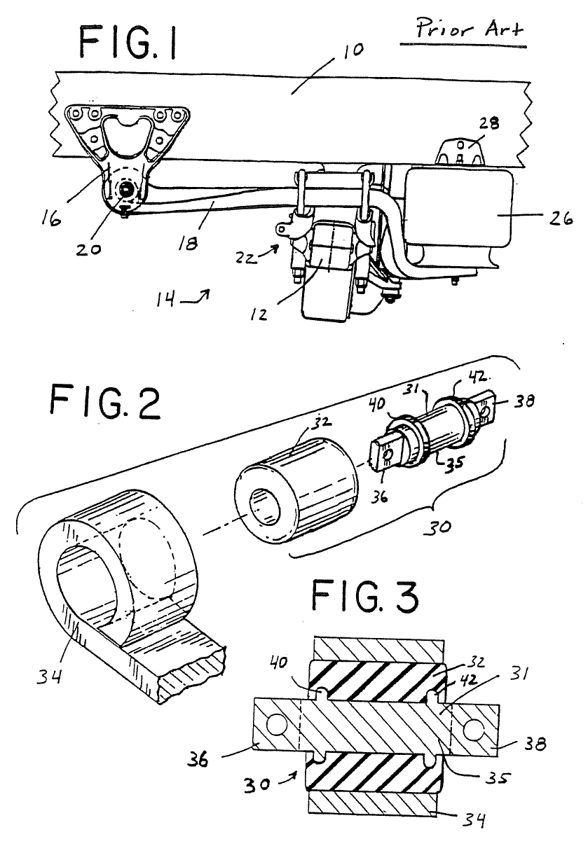

FIGS. 2-3 illustrate a sleeveless bushing 30 adapted to incorporate performance tuning features. In particular, bushing 30 includes an inner metal component 31 and an elastomer 32 bonded thereto. Also shown in FIGS. 2-3 is a leaf spring eye 34.

Inner metal component 31 is shown in the form of a barpin. The inner metal component includes a centrally located elongated body portion 35 and two end portions 36, 38 positioned at opposite ends thereof. End portions 36, 38 include bores extending through them to permit connection of the bushing to another device.

The performance tuning feature of bushing 30 illustrated in FIGS. 2-3 includes ribs or flanges 40, 42 integrally formed or otherwise joined with inner metal component 31 and extending radially outwardly and circumferentially about the elongated body portion 35 of the component. In its preferred form, the performance tuning feature is integrated with the inner metal component 31. For example, ribs 40, 42 can form part of the same casting as the remainder of the inner metal component. Ribs 40, 42 can also be forged with the inner metal component. Alternatively, ribs 40, 42 can be separate pieces that are press fitted or welded to the inner metal component.

Ribs 40, 42 are preferably positioned symmetrically about the axial center of inner metal component 31, and are axially spaced apart from each other. In the illustrated embodiment, ribs 40, 42 are disposed near the ends at which the elastomer 32 surrounds the inner metal component 31, such that they are surrounded by and encapsulated within the elastomer.

Elastomer 32 is preferably bonded to inner metal component 31, and the bushing is installed within the leaf spring eye 34, as illustrated in FIG. 3. Those skilled in the art will appreciate that the geometric configuration and orientation of the ribs 40, 42 of bushing 30 causes the inner metal component to be stiffer conically, while being acceptably compliant torsionally, vertically and in the fore-aft direction, when installed within the leaf spring eye.

In effect, conical stiffness has been increased, without hampering the vertical and fore/aft performance of the bushing. Therefore, this construction permits the conical stiffness of the bushing to be tuned somewhat independently of its other modes.

It will further be appreciated by those skilled in the art that the edges of the ribs 40, 42 are preferably rounded in order to prevent premature cracking of the elastomer at locations adjacent to the ribs.

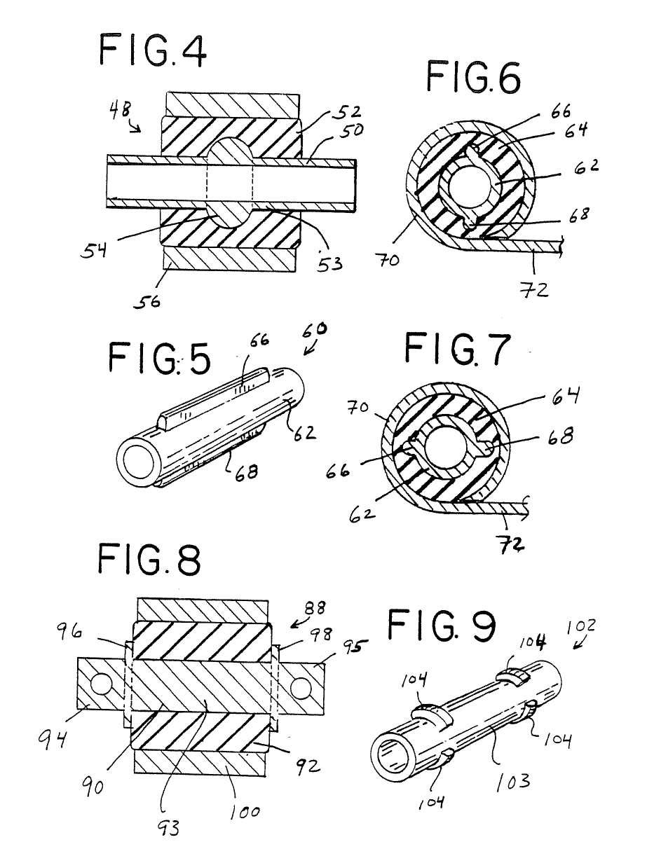

FIG. 4 illustrates a sleeveless bushing 48 having an inner metal component 50 and an elastomer 52 bonded to the component. Those skilled in the art will appreciate that the inner metal component 50 shown in FIG. 4 includes a hollow elongated body portion 53. This configuration accommodates a thru-bolt for installation within the leaf spring eye 56. Alternatively, a barpin construction, such as shown in FIGS. 2 and 3, could be used.

Bushing 48 includes a performance tuning feature 54 integrated with inner metal component 50. In that regard, the performance tuning feature is a centrally located rib or flange 54 extending radially outwardly and circumferentially about the elongated body portion 53 of inner metal component 50. Rib 54 is surrounded by and encapsulated within the elastomer.

As illustrated, the bushing 48 can be installed within a suspension component, such as a leaf spring eye 56. Those skilled in the art will appreciate that the geometric configuration, orientation and position of rib 54 causes bushing 48 to be stiffer vertically and in the fore-aft direction, while being compliant conically, when installed within the leaf spring eye.

In effect, vertical and fore/aft stiffness has been increased, without hampering the conical performance of the bushing. Therefore, this construction permits the stiffness of certain modes of the bushing to be tuned somewhat independently of its other modes.

It will further be appreciated by those skilled in the art that the edge of the rib 54 is preferably rounded in order to prevent premature cracking of the elastomer at locations adjacent to the rib.

FIG. 5 illustrates an inner metal component 60 for a sleeveless bushing. Inner metal component includes a hollow elongated body portion 62 designed to accommodate a thru-bolt for connection to other components when installed within a leaf spring eye. Those skilled in the art will appreciate that inner metal component 60 could alternatively have a barpin construction.

Inner metal component 60 includes performance tuning features integrated therewith. In that regard, the performance tuning features are ribs or flanges 66, 68 extending radially outwardly and axially along the length of the elongated body portion 62 of the inner metal component 60 at diametrically opposite positions thereof.

FIGS. 6 and 7 illustrate a preferred sleeveless bushing that includes an elastomer 64 bonded to inner metal component 60. In those views, the bushing is installed within an eye 70 of a leaf spring having a leaf portion 72. As is the case with the other embodiments of the present invention, the edges of ribs 66, 68 are preferably rounded in order to prevent premature cracking of the elastomer at locations adjacent to the ribs.

In FIG. 6, the bushing is oriented such that ribs 66, 68 are primarily vertically separated within leaf spring eye 70. Those skilled in the art will appreciate that this orientation of this form of the bushing within leaf spring eye 70 causes the bushing to be stiffer vertically and conically along an axis aligned with the ribs 66, 68 (i.e., along a vertical axis). In this orientation, the bushing is compliant conically along any other axis other than the axis aligned with ribs 66,68. The bushing is more (and in fact most) compliant conically along an axis normal to the axis aligned with ribs 66,68 (i.e., along a horizontal (fore-aft extending) axis). The bushing is also compliant in the fore-aft direction.

In FIG. 7, the bushing is oriented such that ribs 66, 68 are primarily separated within leaf spring eye 70 in the fore/aft direction. Those skilled in the art will appreciate that this orientation of this form of the bushing within leaf spring eye 70 causes the bushing to be stiffer in the fore/aft direction and conically along an axis aligned with the ribs 66,68 (i.e., along a horizontal (fore-aft extending)axis). In this orientation, the bushing is compliant conically along any other axis other than the axis aligned with ribs 66,68. The bushing is more (and in fact most) compliant conically along an axis normal to the axis aligned with ribs 66, 68 (i.e., along a vertical axis). The bushing is also compliant vertically.

FIG. 8 illustrates another preferred form of a sleeveless bushing 88 having an inner metal component 90 and an elastomer 92 bonded thereto. Inner metal component 90 includes an elongated central body portion 93 and two end portions 94, 95 at opposite ends thereof. The end portions each include a bore extending through it to permit connection with another device. As such, inner metal component is shown in the form of a barpin. Alternatively, inner metal component 90 could be hollow to accommodate a thru-bolt.

Bushing 88 includes performance tuning features 96, 98 integrated with inner metal component 90. In that regard, the performance tuning features are ribs or flanges 96, 98 that extend radially outwardly from and circumferentially about the elongated body portion 94 of the inner metal component 90.

Ribs 96, 98 are axially separated along the length of the elongated body portion of the inner metal component, at generally opposite ends thereof, and preferably positioned between the elongated body portion 93 of the inner metal component and the end portions of that component.

Bushing 88 is formed such that ribs 96, 98 are positioned axially outwardly from elastomer 92 and are not surrounded by and encapsulated within the elastomer. In this arrangement, elastomer 92 surrounds inner metal component 90 along its elongated body portion, such that the elastomer is positioned between ribs 96, 98.

As shown, the bushing is preferably installed within the leaf spring eye 100. Those skilled in the art will appreciate that this construction of the bushing, and particularly the geometric configuration and orientation of ribs 96, 98, provides axial confinement, which increases axial stiffness of the bushing and serves as a conical hard-stop.

FIG. 9 illustrates an alternative form of an inner metal component 102 for a bushing. Inner metal component 102 includes an elongated body portion 103 and performance tuning features in the form of partially circumferentially extending ribs or flanges 104 that extend radially outwardly from and partially circumferentially about the elongated body portion of the inner metal component. Those skilled in the art will appreciate that the ribs in all of the aforementioned embodiments are not required to extend completely circumferentially about the elongated body portion of the inner metal component. Instead, the performance tuning features may extend only partially circumferentially about the elongated body portion of the inner metal component and, in appropriate circumstances, still provide the desired performance tuning capability. As is the case with the embodiment illustrated in FIGS. 2 and 3, the partially circumferentially extending ribs or flanges 104 shown in FIG. 9 cause the bushing to be stiffer conically, while being compliant vertically and in the fore/aft direction, when installed in a leaf spring eye. Similar constructions are possible for the other embodiments illustrated and described in this specification.

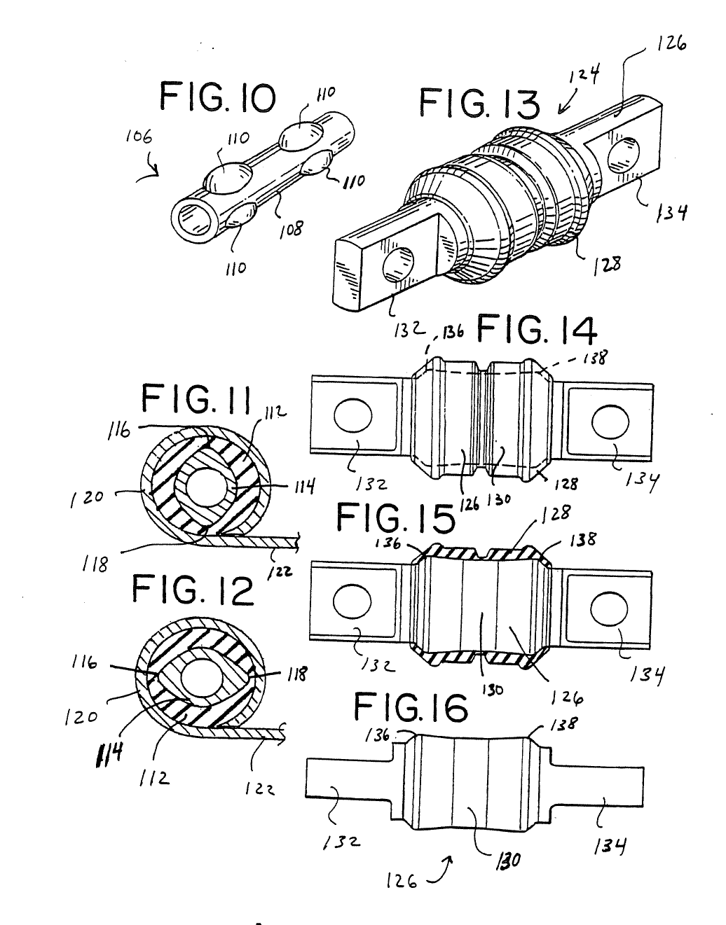

FIG. 10 illustrates an alternative form of an inner metal component 106 for a bushing. Inner metal component 106 includes an elongated body portion 108 and performance tuning features in the form of smooth, rounded elements 110 that extend radially outwardly from the elongated body portion of the inner metal component. As shown, two or more elements 110 may be partially circumferentially disposed about the elongated body portion 108 of inner metal component 106. Preferably, elements 110 will be in the form of dimples, as illustrated. It will be appreciated by those skilled in the art that the smoothness of elements 110 will reduce possible cracking of the bushing elastomer.

Those skilled in the art will further appreciate that, in appropriate circumstances, elements 110 will provide the desired performance tuning capability. As is the case with the embodiments illustrated in FIGS. 2, 3 and 9, the arrangement of elements 110, as shown in FIG. 10 causes the bushing to be stiffer conically, while being compliant vertically and in the fore/aft direction, when installed in a leaf spring eye. Similar constructions are possible for the other embodiments illustrated and described in this specification.

FIGS. 11 and 12 illustrate a preferred sleeveless bushing that includes an elastomer 112 bonded to an inner metal component 114. Inner metal component 114 preferably has a generally uniform cross-section throughout the axial length of its elongated body, as illustrated in FIGS. 11 and 12.

In the illustrative embodiment, inner metal component 114 is hollow and therefore designed to accommodate a thru-bolt for connection to other components when installed within a leaf spring eye. Those skilled in the art will appreciate that inner metal component 114 could alternatively have a barpin construction.

Inner metal component 114 includes performance tuning features integrated therewith. In that regard, the performance tuning features are the radially outwardly projecting tips 116, 118. Tips 116, 118 extend axially along the length of the elongated body portion of inner metal component 114 at diametrically opposite positions thereof.

The performance tuning tips 116, 118 are preferably formed by gradually radially outwardly tapering the outer diameter of the inner metal component 114. In this embodiment, the outer diameter of inner metal component 114 is greatest when measured tip-to-tip and progressively gets smaller as measured at points circumferentially further away from the tips. It will be appreciated by those skilled in the art that the smooth tapering of the outer diameter to form tips 116, 118 will reduce possible cracking of the bushing elastomer.

In FIGS. 11 and 12, the bushing is installed within an eye 120 of a leaf spring having a leaf portion 122. In FIG. 11, the bushing is oriented such that tips 116, 118 are primarily vertically separated within leaf spring eye 120. Those skilled in the art will appreciate that this orientation of this form of the bushing within leaf spring eye 120 causes the bushing to be stiffer vertically and conically along an axis aligned with tips 116, 118 (i.e., along a vertical axis). In this orientation, the bushing is compliant conically along any other axis other than the axis aligned with tips 116, 118. The bushing is also compliant in the fore-aft direction.

In FIG. 12, the bushing is oriented such that ribs 116, 118 are primarily separated within leaf spring eye 120 in the fore/aft direction. Those skilled in the art will appreciate that this orientation of this form of the bushing within leaf spring eye 120 causes the bushing to be stiffer in the fore/aft direction and conically along an axis aligned with tips 116, 118 (i.e., along a horizontal (fore-aft extending) axis). In this orientation, the bushing is compliant conically along any other axis other than the axis aligned with tips 116, 118. The bushing is also compliant vertically.

FIGS. 13-15 illustrate a sleeveless bushing 124 adapted to incorporate performance tuning features. In particular, bushing 124 includes an inner metal component 126 (shown also in FIG. 16) and an elastomer 128 bonded thereto.

Inner metal component 126 is shown in the form of a barpin. The inner metal component includes a centrally located elongated body portion 130 and two end portions 132, 134 positioned at opposite ends thereof. End portions 132, 134 include bores extending through them to permit connection of the bushing to another device.

The performance tuning feature of bushing 124 illustrated in FIGS. 13-16 includes flanges 136, 138 integrally formed or otherwise joined with inner metal component 126 and extending radially outwardly and circumferentially about the elongated body portion 35 of the component. In its preferred form, the performance tuning feature is integrated with the inner metal component 126. For example, flanges 136, 138 can form part of the same casting as the remainder of the inner metal component. Flanges 136, 138 can also be forged with the inner metal component.

Flanges 136, 138 are preferably positioned symmetrically about the axial center of inner metal component 126, and are axially spaced apart from each other. In the illustrated embodiment, flanges 136, 138 are disposed near the ends at which the elastomer 128 surrounds the inner metal component 126, such that they are surrounded by and encapsulated within the elastomer.

Elastomer 128 is preferably bonded to inner metal component 126. Those skilled in the art will appreciate that the geometric configuration and orientation of the flanges 136, 138 of bushing 124 causes the inner metal component to be stiffer conically, while being acceptably compliant torsionally, vertically and in the fore-aft direction, when installed within a leaf spring eye.

In effect, conical stiffness has been increased, without hampering the vertical and fore/aft performance of the bushing. Therefore, this construction permits the conical stiffness of the bushing to be tuned somewhat independently of its other modes.

As illustrated in this embodiment, the central body portion 130 of inner metal component 126 includes a portion having a relatively uniform outer diameter in close proximity to the axial center of the inner metal component. On opposite sides of this portion of inner metal component 126, the outer diameter increases as it tapers and continuously extends radially outward up to and including the rounded tip of flanges 136, 138.

It will be appreciated by those skilled in the art that this construction of inner metal component 126 reduces stress risers that might cause premature cracking of the elastomer at locations adjacent to the inner metal component.

Those skilled in the art will appreciate that the less severe treatment of the inner metal component, such as an elliptical or oval shape as disclosed herein will provide the same performance tuning benefits, while at the same time, minimizing the manufacturing costs and reducing the potential for stress risers to the elastomer. In this regard, the inner metal component may be manufactured using a variety of conventional manufacturing techniques, including being manufactured from drawn stock for a barpin construction and being manufactured by way of a conventional drawn over mandrel tubing forming process for a thru-bolt construction.

Those skilled in the art will appreciate that, while sleeveless bushings have been illustrated and described throughout this specification, the principles of the present invention are suitable for use with traditional three-layer (canned) bushings having an outer metal sleeve. Either form of bushing would still have the performance tuning feature integrated with the inner metal component of the bushing, and would exhibit the benefits associated therewith.

While this invention has been described with reference to certain illustrative aspects, it will be understood that this description shall not be construed in a limiting sense. Rather, various changes and modifications can be made to the illustrative embodiments without departing from the true spirit and scope of the invention, as defined by the following claims. Furthermore, it will be appreciated that any such changes and modifications will be recognized by those skilled in the art as an equivalent to one or more elements of the following claims, and shall be covered by such claims to the fullest extent permitted by law.

1. A bushing, comprising:
an inner metal component comprising a bar pin having a performance tuning feature integrated therewith; and
an elastomer bonded to said bar pin;
wherein said bushing is a sleeveless bushing.

2. (canceled)

3. (canceled)

4. The bushing as defined by claim 1 wherein said performance tuning feature includes a rib.

5. The bushing as defined by claim 4 wherein said rib includes rounded corners.

6. The bushing as defined by claim 4 wherein said rib extends radially outwardly and at least partially circumferentially about the inner metal component.

7. The bushing as defined by claim 6 wherein said rib is centrally located with respect to the inner metal component.

8. The bushing as defined by claim 4 wherein said performance tuning feature further includes a second rib.

9. The bushing as defined by claim 8 wherein said second rib includes rounded corners.

10. The bushing as defined by claim 8 wherein the first and second ribs extend radially outwardly and circumferentially about the inner metal component.

11. The bushing as defined by claim 10 wherein the first and second ribs are axially separated.

12. The bushing as defined by claim 8 wherein the first and second ribs extend axially along the inner metal component.

13. The bushing as defined by claim 12 wherein the first and second ribs are positioned diametrically opposite each other.

14. The bushing as defined by claim 1 wherein said performance tuning feature includes a fully circumferentially extending rib.

15. (canceled)

16. (canceled)

17. A vehicle suspension assembly, comprising:
a sleeveless bushing having an inner metal component comprising a bar pin with an integrated performance tuning feature and an elastomer bonded to said bar pin; and
a leaf spring eye of a leaf spring, said bushing being installed within said leaf spring eye.

18. (canceled)

19. (canceled)

20. The vehicle suspension assembly as defined by claim 17 wherein said performance tuning feature includes a rib.

21. The vehicle suspension assembly as defined by claim 20 wherein said rib includes rounded corners.

22. The vehicle suspension assembly as defined by claim 20 wherein said rib extends radially outwardly and at least partially circumferentially about the inner metal component.

23. The vehicle suspension assembly as defined by claim 22 wherein said rib is centrally located with respect to the inner metal component.

24. The vehicle suspension assembly as defined by claim 20 wherein said performance tuning feature further includes a second rib.

25. The vehicle suspension assembly as defined by claim 24 wherein said second rib includes rounded corners.

26. The vehicle suspension assembly as defined by claim 24 wherein the first and second ribs extend radially outwardly and circumferentially about the inner metal component.

27. The vehicle suspension assembly as defined by claim 26 wherein the first and second ribs are axially separated.

28. The vehicle suspension assembly as defined by claim 24 wherein the first and second ribs extend axially along the inner metal component.

29. The vehicle suspension assembly as defined by claim 28 wherein the first and second ribs are positioned diametrically opposite each other.

30. The vehicle suspension assembly as defined by claim 17 wherein said performance tuning feature includes a fully circumferentially extending rib.

31. (canceled)

32. (canceled)
